(19) United States
(12) Patent Application Publication
(10) Pub. No.: US 2026/0229075 A1
(43) Pub. Date: Aug. 6, 2026

(54) CONTROL DEVICE, CONTROL METHOD, AND RECORDING MEDIUM

(71) Applicant: Sony Honda Mobility Inc., Tokyo (JP)

(72) Inventors: Ryu Tate, Tokyo (JP); Yasuhisa Ito, Tokyo (JP)

(73) Assignee: Sony Honda Mobility Inc., Tokyo (JP)

(21) Appl. No.: 19/043,829

(22) Filed: Feb. 3, 2025

(51) Int. Cl. G07C 5/08; B60Q 9/00; G07C 5/00; G08B 6/00

(52) U.S. Cl. CPC G07C 5/0816; B60Q 9/00; G07C 5/008; G08B 6/00

(57) ABSTRACT

A control device, a control method, and a recording medium for enabling a texture during driving to be reproduced are provided. A control device (100) includes a processor. The processor executes a program to acquire a detection result of a vehicle sensor group (40) that detects at least one of a surrounding situation of the vehicle and a state of the vehicle and cause a vibration device (VD1 or VD2) mounted on a steering wheel (SW) of the vehicle to generate vibrations simulating a texture indicating at least one of the surrounding situation of the vehicle and the state of the vehicle in accordance with the acquired detection result.

### BACKGROUND OF THE INVENTION

### Field of the Invention

The present disclosure relates to a control device, a control method, and a recording medium.

### Description of Related Art

Conventionally, technology for transmitting various types of information to an occupant of a vehicle by vibrating a vibration device mounted on the vehicle is known. For example, the following Patent Document 1 discloses technology for improving fuel efficiency by providing a vibration device on a pedal and vibrating the vibration device to change a manipulation situation of the pedal. Moreover, the following Patent Document 2 discloses technology for prompting an occupant of a vehicle to perform a shift manipulation by providing a vibration device on a steering wheel of the vehicle and vibrating the vibration device at a timing when the shift manipulation should be performed.

### [Patent Documents]

[Patent Document 1] U.S. Pat. No. 8,290,697

[Patent Document 2] U.S. Pat. No. 9,188,223

### SUMMARY OF THE INVENTION

Meanwhile, a shift from gasoline vehicles to electric vehicles (EVs) is currently underway to reduce greenhouse gases. Compared to gasoline vehicles, in EVs, information during movement tends to be lacking and it is difficult for an occupant to ascertain a road surface situation or a vehicle state during driving, such that a texture during driving deteriorates. For this reason, the EV is required to reproduce a texture during driving by feeding back information corresponding to a road surface situation or a vehicle state to an occupant during movement.

The present disclosure has been made in view of the above-described circumstances and an objective of the present disclosure is to provide a control device, a control method, and a recording medium for enabling a texture during driving to be reproduced.

To solve the above-described problems, according to a first aspect of the present disclosure, there is provided a control device (100 or 100A) for controlling vibrations generated by a vibration device (VD1 or VD2) mounted on a driving manipulation element (SW) of a vehicle (M), the control device including: a processor, wherein the processor executes a program to acquire a detection result of a detection sensor that detects at least one of a surrounding situation of the vehicle and a state of the vehicle, and cause the vibration device to generate vibrations simulating a texture indicating at least one of the surrounding situation of the vehicle and the state of the vehicle in accordance with the acquired detection result.

According to a second aspect of the present disclosure, in the control device according to the first aspect of the present disclosure, the processor may generate the vibrations simulating the texture indicating at least one of the surrounding situation of the vehicle and the state of the vehicle on the basis of the acquired detection result.

According to a third aspect of the present disclosure, in the control device according to the second aspect of the present disclosure, the processor may generate a noise signal, perform a plurality of filtering processes on the generated noise signal, adjust envelopes of the signal on which the filtering processes are performed, and synthesize signals whose envelopes are adjusted.

According to a fourth aspect of the present disclosure, in the control device according to the third aspect of the present disclosure, the processor may perform a process of multiplying the synthesized signals by an inverse function of a transfer function of the vehicle.

According to a fifth aspect of the present disclosure, in the control device according to the first aspect of the present disclosure, the processor may transmit the acquired detection result to a server device (300), receive definition information for defining the vibrations simulating the texture indicating at least one of the surrounding situation of the vehicle and the state of the vehicle transmitted from the server device in accordance with the detection result transmitted to the server device, and cause the vibration device to generate the vibrations based on the received definition information.

According to a sixth aspect of the present disclosure, in the control device according to any one of the first to fifth aspects of the present disclosure, the processor may perform control so that a vibration intensity of the vibration device gradually increases or decreases within a prespecified transition period at a start or end of the vibrations of the vibration device.

According to a seventh aspect of the present disclosure, in the control device according to any one of the first to sixth aspects of the present disclosure, the processor may cause the vibration device to generate the vibrations simulating an ice feeling when a road surface is frozen.

According to an eighth aspect of the present disclosure, in the control device according to any one of the first to seventh aspects of the present disclosure, the processor may cause the vibration device to generate the vibrations simulating a tire-deflating feeling.

According to an aspect of the present disclosure, there is provided a control method for controlling vibrations generated by a vibration device (VD1 or VD2) mounted on a driving manipulation element (SW) of a vehicle (M), the control method including: acquiring, by a computer, a detection result of a detection sensor (40) that detects at least one of a surrounding situation of the vehicle and a state of the vehicle (S11), and causing, by the computer, the vibration device to generate vibrations simulating a texture indicating at least one of the surrounding situation of the vehicle and the state of the vehicle in accordance with the acquired detection result (S14).

According to an aspect of the present disclosure, there is provided a computer-readable non-transitory recording medium recording a program for causing a computer to acquire a detection result of a detection sensor (40) that detects at least one of a surrounding situation of a vehicle (M) and a state of the vehicle (S11), and cause a vibration device mounted on a driving manipulation element of the vehicle to generate vibrations simulating a texture indicating at least one of the surrounding situation of the vehicle and the state of the vehicle in accordance with the acquired detection result (S14).

According to the present disclosure, a special operation effect of reproducing a texture during driving can be obtained.

### BRIEF DESCRIPTION OF THE DRAWINGS

FIG. 1 is a diagram schematically showing the interior of a cabin of a vehicle according to a first embodiment of the present disclosure.

FIG. 2 is a block diagram showing an exemplary configuration of a vehicle control system including a control device according to the first embodiment of the present disclosure.

FIG. 3 is a block showing an internal configuration of a generation unit according to the first embodiment of the present disclosure.

FIG. 4 is a diagram showing an example of a signal waveform generated by the generation unit in the first embodiment of the present disclosure.

FIG. 5 is an explanatory diagram of the control of a vibration device in the first embodiment of the present disclosure.

FIG. 6 is a flowchart showing an example of a control method according to the first embodiment of the present disclosure.

FIG. 7 is a block diagram showing a key configuration of a control device according to a second embodiment of the present disclosure.

### DETAILED DESCRIPTION OF THE INVENTION

Hereinafter, a control device, a control method, and a recording medium according to the embodiment of the present disclosure will be described in detail with reference to the drawings.

### First Embodiment

### <Vehicle>

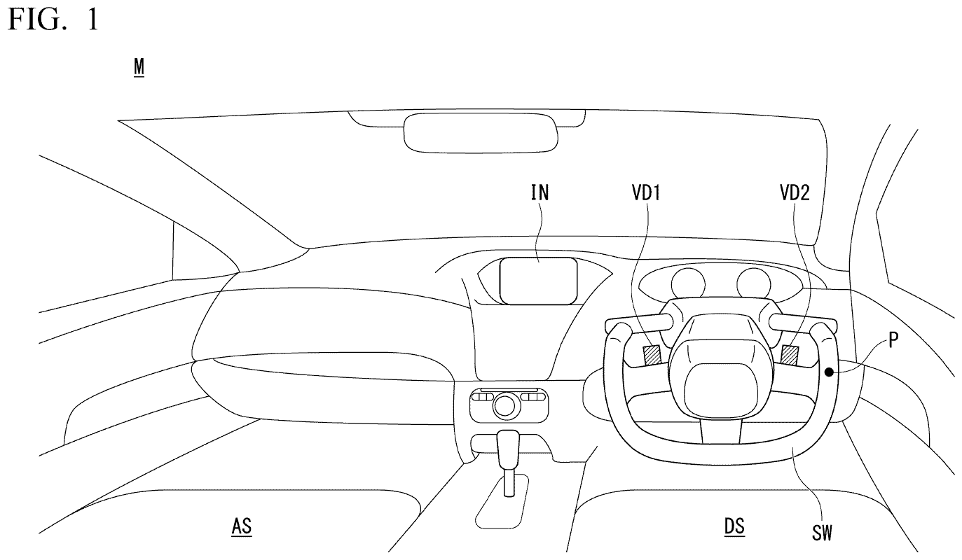

FIG. 1 is a diagram schematically showing the interior of a cabin of a vehicle according to a first embodiment of the present disclosure. As shown in FIG. 1, a vehicle M includes an instrument panel IN, a driver's seat DS, a passenger seat AS, a steering wheel SW, and the like in the vehicle cabin. The vehicle M is, for example, a vehicle such as a two-, three-, or four-wheeled vehicle, and its drive source is an internal combustion engine such as a diesel engine or a gasoline engine, an electric motor, or a combination thereof. In the present embodiment, the vehicle M will be described with reference to an example of a four-wheeled vehicle (EV) having an electric motor as a drive source.

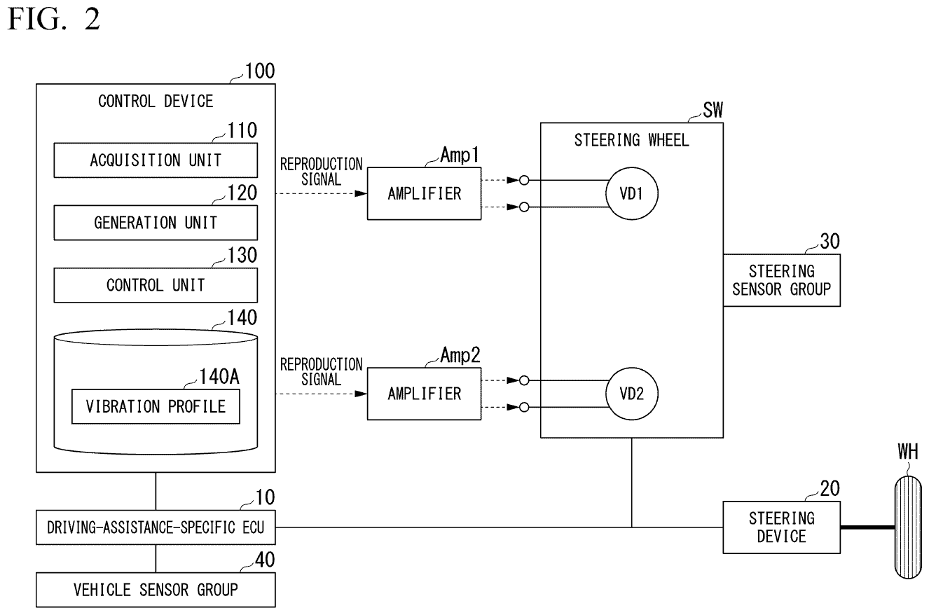

The steering wheel SW is a driving manipulation element that is manipulated by a driver of the vehicle M. A sensor that detects a manipulation amount or the presence or absence of a manipulation is attached to the steering wheel SW and its detection result is output to a driving-assistance-specific support electronic control unit (ECU) 10 and a steering device 20 (see FIG. 2). The steering wheel SW does not necessarily have to be annular, and may be an irregular steering wheel.

Moreover, the steering wheel SW is equipped with vibration devices VD1 and VD2 on the left and right sides of the steering wheel SW. The vibration devices VD1 and VD2 each have a built-in motor and generate vibrations on the steering wheel SW by operating the motor in response to a reproduction signal output from a control device 100 (see FIG. 2). The motors built into the vibration devices VD1 and VD2 may be direct-acting motors (for example, voice coil motors) or rotary motors (for example, direct current (DC) motors).

The vibration device VD1 is installed on the left side of the steering wheel SW and is used to transmit vibrations to the left hand of the driver who grips the steering wheel SW. The vibration device VD2 is installed on the right side of the steering wheel SW and is used to transmit vibrations to the right hand of the driver who grips the steering wheel SW.

<vehicle Control System>

FIG. 2 is a block diagram showing an exemplary configuration of a vehicle control system including a control device according to the first embodiment of the present disclosure. As shown in FIG. 2, the control system of the vehicle M includes the driving-assistance-specific ECU 10, the steering device 20, a steering sensor group 30, a vehicle sensor group 40 (a detection sensor), amplifiers Amp1 and Amp2, and a control device 100.

The driving-assistance-specific ECU 10 executes an advanced driver assistance system (ADAS) for the driver on the basis of a detection result of the vehicle sensor group 40. The ADAS includes, for example, a lane departure warning (LDW) that warns of the departure of the vehicle M from a travel lane. As an example, the driving-assistance-specific ECU 10 executes the ADAS by generating vibrations from the vibration devices VD1 and VD2 via the control device 100.

The steering device 20 includes, for example, a steering ECU and an electric motor. The steering ECU drives the electric motor according to information output from the driving-assistance-specific ECU 10 or information output from the steering wheel SW and causes the direction of the steering wheel to change. The electric motor, for example, acts a force on a rack and pinion mechanism to change the direction of the steering wheel.

The steering sensor group 30 is a sensor group attached to the steering wheel SW. The steering sensor group 30 includes, for example, a steering grip sensor and a vibration displacement sensor. The steering grip sensor is implemented by a capacitive sensor or the like and outputs a signal for detecting whether or not the driver is gripping the steering wheel SW (indicating that there is contact with the steering wheel SW in a state in which a force is applied) to the driving-assistance-specific ECU 10. The vibration displacement sensor measures the displacement [cm] of the vibrations generated at each position (point) of the steering wheel SW as the vibration intensity and outputs the measured vibration intensity to the control device 100. Furthermore, the vibration intensity measured by the vibration displacement sensor may be directly output to the control device 100 without going through the driving-assistance-specific ECU 10.

The vehicle sensor group 40 includes a sensor indicating a surrounding situation of the vehicle M and a sensor indicating a state of the vehicle M. The sensor indicating the surrounding situation of the vehicle M includes an image sensor, an outside air temperature sensor, and the like installed to image the surrounding situation of the vehicle M. The sensor indicating the state of the vehicle M includes a vehicle speed sensor that detects a speed of the vehicle M, an acceleration sensor that detects acceleration, a yaw rate sensor that detects an angular velocity around a vertical axis, a direction sensor that detects a direction of the vehicle M, an air pressure sensor that detects the air pressure of a tire, and the like. Furthermore, as the image sensor, for example, a solid-state image sensor such as a charge-coupled device (CCD) or a complementary metal oxide semiconductor (CMOS) can be used.

The amplifiers Amp1 and Amp2 amplify a reproduction signal output from the control device 100, respectively. The amplifier Amp1 outputs the amplified reproduction signal to the vibration device VD1 and the amplifier Amp2 outputs the amplified reproduced signal to the vibration device VD2. The amplifiers Amp1 and Amp2 are connected to the vibration devices VD1 and VD2, respectively, via a cable reel.

<control Device>

The control device 100 includes, for example, an acquisition unit 110, a generation unit 120, a control unit 130, and a storage unit 140. The acquisition unit 110 acquires detection results of various types of sensors provided in the vehicle sensor group 40. The acquisition unit 110 outputs the acquired detection results to the generation unit 120 and the control unit 130 as detection data. Furthermore, the detection data may be stored in the storage unit 140.

The generation unit 120 generates a vibration profile that is definition information for defining the vibrations (more specifically, vibration intensities, frequency and phases) of the vibration devices VD1 and VD2 in accordance with the detection results acquired by the acquisition unit 110. The vibration profile generated by the generation unit 120 is for alerting the driver to a change in the surrounding situation of the vehicle M or a change in the state of the vehicle M.

The generation unit 120 generates a vibration profile that defines vibrations simulating a feeling corresponding to the road surface situation in accordance with the detection result of the sensor indicating the surrounding situation of the vehicle M provided in the vehicle sensor group 40. For example, the generation unit 120 generates a vibration profile that defines vibrations simulating an ice feeling when the road surface is frozen in accordance with the detection result of the outside air temperature sensor provided in the vehicle sensor group 40. Furthermore, in addition to the ice feeling when the road surface is frozen, the generation unit 120 may generate a vibration profile that defines vibrations simulating a feeling of the road surface during rainfall and a feeling of the road surface on a sand or muddy ground (for example, a dirt course).

The generation unit 120 generates a vibration profile that defines vibrations simulating a feeling corresponding to the state of the vehicle M in accordance with the detection result of the sensor indicating the state of the vehicle M provided in the vehicle sensor group 40. For example, the generation unit 120 generates a vibration profile that defines vibrations simulating a tire-deflating feeling in accordance with the detection result of the air pressure sensor provided in the vehicle sensor group 40. Furthermore, in addition to the tire-deflating feeling, the generation unit 120 may generate a vibration profile that defines vibrations for providing a notification of a state of a drive source (an electric motor) or a battery. Furthermore, details of a method for generating a vibration profile will be described below.

The control unit 130 vibrates the vibration devices VD1 and VD2 in accordance with the vibration profile generated by the generation unit 120 or a vibration profile 140A stored in the storage unit 140. For example, when the vibration devices VD1 and VD2 are vibrated, the control unit 130 may change vibration intensities and phases of the vibration devices VD1 and VD2 in consideration of a positional relationship of the vibration devices VD1 and VD2 and a predetermined point P (see FIG. 1). Furthermore, in the present embodiment, the predetermined point P is a position on the steering wheel SW that is generally assumed to be most frequently gripped by the driver of the vehicle M during driving and is decided in advance.

For example, when the predetermined point P is located on the right side of the steering wheel SW, the vibrations of the vibration device VD1 can be prevented from propagating to the predetermined point P by changing the vibration intensity and phase of the vibration device VD1. Likewise, for example, when the predetermined point P is located on the left side of the steering wheel SW, the vibration intensity and phase of the vibration device VD1 can be changed to prevent the vibrations of the vibration device VD2 from propagating to the predetermined point P. As a result, the driver can more clearly feel the vibrations on the left side of the steering wheel SW.

The storage unit 140 stores, for example, the vibration profile 140A, various types of parameters necessary for the generation unit 120 to generate the vibration profile, and the like. The vibration profile 140A is definition information for defining the vibrations (more specifically, the vibration intensities, frequency and phases) of the vibration devices VD1 and VD2. The vibration profile 140A is similar to the vibration profile generated by the generation unit 120, except that the vibration profile 140A is generated in advance and stored in the storage unit 140. That is, the vibration profile 140A includes, for example, a vibration profile that defines vibrations simulating an ice feeling when the road surface is frozen, a vibration profile that defines vibrations simulating a tire-deflating feeling, and the like.

The acquisition unit 110, the generation unit 120, and the control unit 130 are implemented by, for example, a hardware processor such as a central processing unit (CPU) executing a program (software). Moreover, some or all of these constituent elements may be implemented by hardware (including a circuit unit; circuitry) such as a large-scale integration (LSI) circuit, an application-specific integrated circuit (ASIC), a field-programmable gate array (FPGA), a graphics processing unit (GPU), and a system on chip (SOC) or may be implemented by software and hardware in cooperation.

The program may be stored in a storage device such as a hard disk drive (HDD) or flash memory (a storage device including a non-transitory storage medium) of the control device 100 in advance. Alternatively, the program may be stored in a removable recording medium such as a DVD or CD-ROM and installed in the HDD or flash memory of the control device 100 when the recording medium (non-transitory recording medium) is mounted on a drive device.

The storage unit 140 is implemented by a storage device such as an HDD, a flash memory, or a random-access memory (RAM). The storage unit 140 may be fixed to the control device 100 or may be detachably provided on the control device 100.

### <Vibration Profile Generation Method>

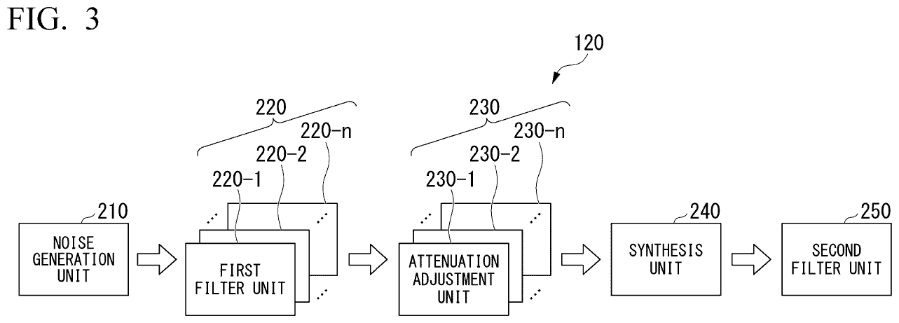

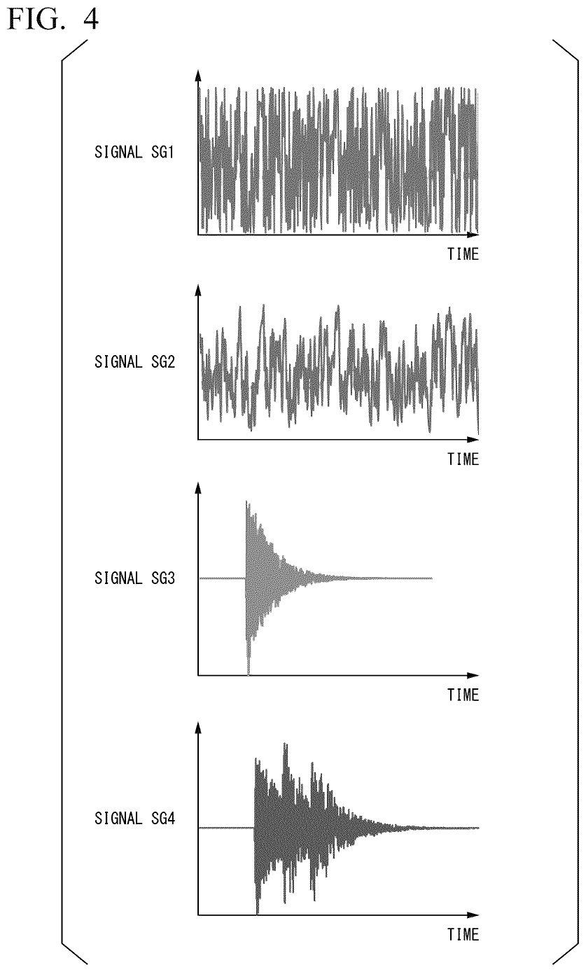

FIG. 3 is a block showing an internal configuration of the generation unit in the first embodiment of the present disclosure. FIG. 4 is a diagram showing an example of a signal waveform generated by the generation unit in the first embodiment of the present disclosure. As shown in FIG. 3, the generation unit 120 includes a noise generation unit 210, a first filter unit 220, an envelope adjustment unit 230, a synthesis unit 240, and a second filter unit 250.

The noise generation unit 210 generates a noise signal. The noise signal generated by the noise generation unit 210 is, for example, a signal including pink or white noise. Furthermore, the noise signal generated by the noise generation unit 210 is not limited to a signal including pink noise or white noise and may include any noise. In FIG. 4, the noise signal generated by the noise generation unit 210 is illustrated as a signal SG1.

The first filter unit 220 includes a plurality of frequency filters 220-1 to 220-n (n is an integer of 2 or more). Each of the frequency filters 220-1 to 220-n is, for example, a bandpass filter that passes a frequency in only a predetermined frequency band. Furthermore, each of the frequency filters 220-1 to 220-n may be a low-pass filter that passes a frequency less than or equal to a predetermined frequency or a high-pass filter that passes a frequency greater than or equal to the predetermined frequency.

The pass frequency bands of the frequency filters 220-1 to 220-n can be set individually. By adjusting the pass frequency bands of the frequency filters 220-1 to 220-n, for example, vibrations simulating the ice feeling when the road surface is frozen or vibrations simulating the tire-deflating feeling can be generated. In FIG. 4, a signal filtered by any one of the frequency filters 220-1 to 220-n is illustrated as a signal SG2.

The envelope adjustment unit 230 includes a plurality of attenuation adjustment units 230-1 to 230-n. The attenuation adjustment units 230-1 to 230-n are each provided in association with the frequency filters 220-1 to 220-n. The attenuation adjustment units 230-1 to 230-n attenuate signals output from the corresponding frequency filters 220-1 to 220-n. That is, the envelope adjustment unit 230 adjusts the envelope of the signal output from each of the frequency filters 220-1 to 220-n.

An attenuation amount, an attenuation coefficient, and an attenuation method in the attenuation adjustment units 230-1 to 230-n can be set individually. By individually adjusting the attenuation amount in the attenuation adjustment units 230-1 to 230-n, for example, vibrations simulating the ice feeling when the road surface is frozen or vibrations simulating the tire-deflating feeling can be generated. In FIG. 4, a signal attenuated by any one of the attenuation adjustment units 230-1 to 230-n is illustrated as a signal SG3.

The synthesis unit 240 synthesizes signals output from the attenuation adjustment units 230-1 to 230-n of the envelope adjustment unit 230. For example, the synthesis unit 240 performs a synthesis process by superimposing the signals output from the attenuation adjustment units 230-1 to 230-n. Furthermore, when the synthesis unit 240 synthesizes the signals output from the attenuation adjustment units 230-1 to 230-n output from the attenuation adjustment units 230-1 to 230-n, the intensity of the signal output from each of the attenuation adjustment units 230-1 to 230-n may be adjusted.

The second filter unit 250 performs a process of multiplying the signals synthesized by the synthesis unit 240 by an inverse function of a vibration transfer function of the vehicle M. This process is performed so that the signals synthesized by the synthesis unit 240 are reproduced at a position where the vibrations are reproduced (for example, at positions where the vibration devices VD1 and VD2 are provided or at the predetermined point P). Thereby, a vibration profile is generated.

<control of Vibration Devices>

As described above, the control unit 130 vibrates the vibration devices VD1 and VD2 in accordance with the vibration profile generated by the generation unit 120 or the vibration profile 140A stored in the storage unit 140. When the vibration devices VD1 and VD2 are vibrated in accordance with the vibration profile, the control unit 130 performs control so that the vibration intensities of the vibration devices VD1 and VD2 gradually increase or decrease within a prespecified transition period at the start or end of the vibrations. This control is performed to prevent the occurrence of the failure or abnormal noise in the vibration devices VD1 and VD2 by softening the sudden operations of the vibration devices VD1 and VD2.

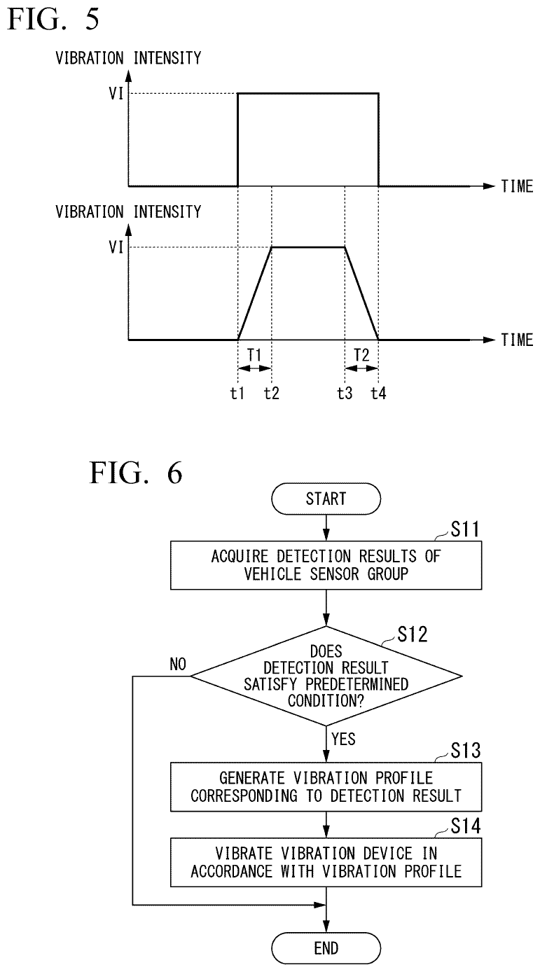

FIG. 5 is an explanatory diagram of the control of a vibration device in the first embodiment of the present disclosure. For example, as shown in the upper graph of FIG. 5, it is assumed that the vibration profile for use in the control unit 130 causes the vibrations having a vibration intensity of VI to start at time t1 and causes the vibrations having the vibration intensity of VI to end at time t4. As shown in the lower graph of FIG. 5, the control unit 130 performs control so that the vibration intensity gradually increases from 0 within a transition period T1 set between times t1 and t2 at the start of the vibrations and the vibration intensity becomes V1 at time t2. Moreover, the control unit 130 performs control so that the vibration intensity gradually decreases from VI within a transition period T2 set between times t3 and t4 at the end of the vibrations and the vibration intensity becomes 0 at time t4.

Although an example in which the vibration intensity increases linearly within the transition period T1 and the vibration intensity decreases linearly within the transition period T2 is shown in the example shown in FIG. 5, a method for changing the vibration intensity within the transition periods T1 and T2 is optional. For example, the vibration intensity may be increased or decreased in a curved or exponential manner, and may be increased or decreased step by step. Moreover, the lengths of the transition periods T1 and T2 are set to, for example, about 5 to 10 [ms]. However, the lengths of the transition periods T1 and T2 are not limited to about 5 to 10 [ms], and can be set to any lengths.

### <Control Method>

FIG. 6 is a flowchart showing an example of a control method according to the first embodiment of the present disclosure. Furthermore, the process of the flowchart shown in FIG. 6 is iteratively executed, for example, at regular time intervals. When the process shown in FIG. 6 begins, the acquisition unit 110 of the control device 100 first acquires detection results of the vehicle sensor group 40 (step S11). For example, the acquisition unit 110 acquires detection results of the outside air temperature sensor, the air pressure sensor, and the other sensors provided in the vehicle sensor group 40. Furthermore, the detection results acquired by the acquisition unit 110 are output to the generation unit 120 and the control unit 130.

Subsequently, the control unit 130 of the control device 100 determines whether or not the detection result acquired by the acquisition unit 110 satisfies a predetermined condition (step S12). For example, the control device 100 determines whether or not the detection result of the outside air temperature sensor is less than or equal to a prespecified reference temperature. Alternatively, the control device 100 determines whether or not the detection result of the air pressure sensor is less than or equal to a prespecified reference pressure. Furthermore, the above-described reference temperature is, for example, a temperature at which road surface freezing occurs (or a temperature at which road surface freezing can occur). Moreover, the above-described reference pressure is, for example, a pressure at which a tire air pressure adjustment is required.

When the control unit 130 determines that the detection result acquired by the acquisition unit 110 does not satisfy a predetermined condition (when the determination result in step S12 is “NO”), the process of the flowchart shown in FIG. 6 ends. On the other hand, when the control unit 130 determines that the detection result acquired by the acquisition unit 110 satisfies the predetermined condition (when the determination result in step S12 is “YES”), the generation unit 120 generates a vibration profile corresponding to the detection result (step S13).

For example, when the detection result of the outside air temperature sensor is less than or equal to the reference temperature, the generation unit 120 generates a vibration profile that defines vibrations simulating an ice feeling when the road surface is frozen. Alternatively, when the detection result of the air pressure sensor is less than or equal to the reference pressure, the generation unit 120 generates a vibration profile that defines vibrations simulating a tire-deflating feeling. Furthermore, the generation unit 120 generates a vibration profile by the method described with reference to FIGS. 3 and 4.

Subsequently, the control unit 130 vibrates the vibration devices VD1 and VD2 in accordance with the vibration profile generated by the generation unit 120 (step S14). For example, the control unit 130 vibrates the vibration devices VD1 and VD2 in accordance with a vibration profile that defines vibrations simulating the ice feeling when the road surface is frozen. Thereby, the ice feeling is reproduced when the road surface is frozen. Alternatively, the control unit 130 vibrates the vibration devices VD1 and VD2 in accordance with a vibration profile that defines vibrations simulating the tire-deflating feeling. Thereby, the tire-deflating feeling is reproduced.

By performing the above-described process, vibrations simulating a texture indicating at least one of the surrounding situation of the vehicle M and the state of the vehicle M is generated in the vibration devices VD1 and VD2. Thereby, a texture indicating at least one of the surrounding situation of the vehicle M and the state of the vehicle M is reproduced.

Furthermore, an example in which the generation unit 120 generates a vibration profile (step S13) and the control unit 130 vibrates the vibration devices VD1 and VD2 in accordance with the generated vibration profile (step S14) has been described with reference to FIG. 6. However, the step of reading the vibration profile 140A corresponding to the detection result from the storage unit 140 may be executed instead of step S13. Thereby, the vibration profile 140A corresponding to the detection result of the vehicle sensor group 40 is read from the storage unit 140 and the vibration devices VD1 and VD2 are vibrated in accordance with the read vibration profile.

As described above, in the present embodiment, the acquisition unit 110 acquires the detection results of the vehicle sensor group 40 that detects at least one of the surrounding situation of the vehicle M and the state of the vehicle M. Also, according to the detection results acquired by the acquisition unit 110, the control unit 130 causes the vibration devices VD1 and VD2 to generate vibrations simulating a texture indicating at least one of the surrounding situation of the vehicle M and the state of the vehicle M. Thereby, for example, it is possible to reproduce the texture during driving such as the ice feeling when the road surface is frozen or the tire-deflating feeling.

### Second Embodiment

### <Control Device>

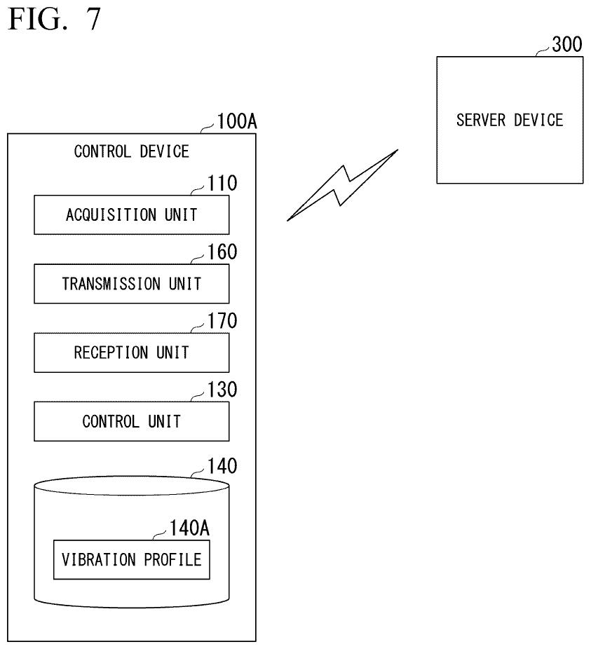

FIG. 7 is a block diagram showing a key configuration of a control device according to a second embodiment of the present disclosure. Furthermore, like the control device 100 shown in FIG. 2, a control device 100A of the present embodiment is mounted on the vehicle and causes vibration devices VD1 and VD2 to generate vibrations on a steering wheel SW.

As shown in FIG. 7, the control device 100A of the present embodiment has a configuration of a transmission unit 160 and a reception unit 170 instead of the generation unit 120 of the control device 100 shown in FIG. 2. The control device 100 of the first embodiment uses the vibration profile 140A stored in the storage unit 140 or the vibration profile generated by the generation unit 120. On the other hand, the control device 100A of the present embodiment uses a vibration profile transmitted from a server device 300.

The transmission unit 160 and the reception unit 170 are wirelessly connected to the server device 300. For example, the transmission unit 160, the reception unit 170, and the server device 300 are wirelessly connected through 4G (a fourth-generation mobile communication system) or 5G (a fifth-generation mobile communication system). Connection forms between the transmission unit 160 and the reception unit 170 and the server device 300 are not limited to 4G or 5G and may be any connection forms. In the transmission unit 160 and the reception unit 170, information indicating the address of the server device 300 is preset. The transmission unit 160 and the reception unit 170 can communicate with the server device 300 by identifying the server device 300 through an address.

The transmission unit 160 transmits detection results of a vehicle sensor group 40 acquired by an acquisition unit 110 to the server device 300. For example, in step S12 of FIG. 6, the transmission unit 160 may transmit only a detection result of a control unit 130 determining that a predetermined condition is satisfied to the server device 300. The reception unit 170 receives the vibration profile transmitted from the server device 300 as a reply to the detection result transmitted by the transmission unit 160. The reception unit 170 outputs the received vibration profile to the control unit 130. Furthermore, the vibration profile received by the reception unit 170 may be stored in a storage unit 140.

The server device 300 transmits a vibration profile corresponding to the detection result transmitted from the control device 100A to the control device 100A. For example, the server device 300 includes a part similar to the generation unit 120 described with reference to FIG. 3 and a vibration profile corresponding to the detection result transmitted from the control device 100A may be generated by the method described with reference to FIGS. 3 and 4. Furthermore, the method by which the server device 300 generates the vibration profile is not limited to the method described with reference to FIGS. 3 and 4 and may be another method.

Alternatively, the server device 300 may store a wide variety of vibration profiles in advance, read the vibration profile corresponding to the detection result transmitted from the control device 100A, and transmit the read vibration profile to the control device 100A. Because the server device 300 can include a storage unit having a larger capacity than the storage unit 140 mounted on the vehicle M, a wide variety of vibration profiles can be stored.

### <Control Method>

The control method of the present embodiment is similar to that of the first embodiment, except that the vibration profile transmitted from the server device 300 is used. That is, in the control method according to the second embodiment of the present disclosure, for example, “generating a vibration profile corresponding to the detection result” in step S13 shown in FIG. 6 is replaced with “transmitting the detection result to the server device and receiving the vibration profile transmitted from the server device.” Hereinafter, the control method of the second embodiment will be described with reference to FIG. 6 whose part of the control method is replaced.

In the present embodiment, when the process begins, the acquisition unit 110 of the control device 100 acquires a detection result of the vehicle sensor group 40 as in the first embodiment (step S11). Subsequently, the control unit 130 of the control device 100 determines whether or not the detection result acquired by the acquisition unit 110 satisfies a predetermined condition (step S12). When the control unit 130 determines that the detection result acquired by the acquisition unit 110 does not satisfy the predetermined condition (when the determination result in step S12 is “NO”), the process of the flowchart shown in FIG. 6 ends.

On the other hand, when the control unit 130 determines that the detection result acquired by the acquisition unit 110 satisfies the predetermined condition (when the determination result in step S12 is “YES”), the transmission unit 160 transmits a detection result indicating that the predetermined condition is satisfied to the server device 300. Also, the reception unit 170 receives the vibration profile transmitted from the server device 300 as a reply to the detection result transmitted by the transmission unit 160 (step S13 of the replacement).

Subsequently, the control unit 130 vibrates vibration devices VD1 and VD2 according to the vibration profile generated by the generation unit 120 (step S14). For example, the control unit 130 vibrates the vibration devices VD1 and VD2 according to a vibration profile that defines vibrations simulating an ice feeling when a road surface is frozen. Thereby, the ice feeling when the road surface is frozen is reproduced. Alternatively, the control unit 130 vibrates the vibration devices VD1 and VD2 according to a vibration profile that defines vibrations simulating a tire-deflating feeling. Thereby, the tire-deflating feeling is reproduced.

By performing the above-described process, vibrations simulating a texture indicating at least one of the surrounding situation of the vehicle M and the state of the vehicle M are generated by the vibration devices VD1 and VD2. Thereby, a texture indicating at least one of the surrounding situation of the vehicle M and the state of the vehicle M is reproduced.

As described above, in the present embodiment, the acquisition unit 110 acquires a detection result of the vehicle sensor group 40 that detects at least one of the surrounding situation of the vehicle M and the state of the vehicle M. Also, according to the detection result acquired by the acquisition unit 110, the control unit 130 causes the vibration devices VD1 and VD2 to generate vibrations simulating a texture indicating at least one of the surrounding situation of the vehicle M and the state of the vehicle M. Thereby, for example, it is possible to reproduce the texture during driving such as the ice feeling when the road surface is frozen or the tire-deflating feeling.

Although the control device, the control method, and the recording medium according to the embodiments of the present disclosure have been described above, the present disclosure is not limited to the above-described embodiments and can be freely changed within the scope of the present disclosure. For example, the server device 300 described in the above-described second embodiment may be implemented in a cloud computing system.

Moreover, when the vibration devices VD1 and VD2 are vibrated, vibrations in an audible range may be superimposed on the original vibrations. Alternatively, the vibrations in the audible range are emitted from a speaker in synchronization with the vibrations of the vibration devices VD1 and VD2. Thereby, hearing is reproduced in addition to a feeling, such that it is possible to better reproduce a texture during driving.

Moreover, in the above-described second embodiment, as in the first embodiment, when the vibration devices VD1 and VD2 are vibrated in accordance with the vibration profile, the control unit 130 performs control so that the vibration intensities of the vibration devices VD1 and VD2 gradually increase or decrease within a prespecified transition period at the start or end of the vibrations. Thereby, in the second embodiment, it is also possible to prevent the occurrence of the failure or abnormal noise in the vibration devices VD1 and VD2 by softening the sudden operations of the vibration devices VD1 and VD2.

What is claimed is:

1. A control device for controlling vibrations generated by a vibration device mounted on a driving manipulation element of a vehicle, the control device comprising:
a processor,
wherein the processor executes a program to acquire a detection result of a detection sensor that detects at least one of a surrounding situation of the vehicle and a state of the vehicle, and
cause the vibration device to generate vibrations simulating a texture indicating at least one of the surrounding situation of the vehicle and the state of the vehicle in accordance with the acquired detection result.

2. The control device according to claim 1, wherein the processor generates the vibrations simulating the texture indicating at least one of the surrounding situation of the vehicle and the state of the vehicle on the basis of the acquired detection result.

3. The control device according to claim 2, wherein the processor
generates a noise signal,
performs a plurality of filtering processes on the generated noise signal,
adjusts envelopes of the signal on which the filtering processes are performed, and
synthesizes signals whose envelopes are adjusted.

4. The control device according to claim 3, wherein the processor performs a process of multiplying the synthesized signals by an inverse function of a transfer function of the vehicle.

5. The control device according to claim 1, wherein the processor
transmits the acquired detection result to a server device,
receives definition information for defining the vibrations simulating the texture indicating at least one of the surrounding situation of the vehicle and the state of the vehicle transmitted from the server device in accordance with the detection result transmitted to the server device, and
causes the vibration device to generate the vibrations based on the received definition information.

6. The control device according to claim 1, wherein the processor performs control so that a vibration intensity of the vibration device gradually increases or decreases within a prespecified transition period at a start or end of the vibrations of the vibration device.

7. The control device according to claim 1, wherein the processor causes the vibration device to generate the vibrations simulating an ice feeling when a road surface is frozen.

8. The control device according to claim 1, wherein the processor causes the vibration device to generate the vibrations simulating a tire-deflating feeling.

9. A control method for controlling vibrations generated by a vibration device mounted on a driving manipulation element of a vehicle, the control method comprising:
acquiring, by a computer, a detection result of a detection sensor that detects at least one of a surrounding situation of the vehicle and a state of the vehicle, and
causing, by the computer, the vibration device to generate vibrations simulating a texture indicating at least one of the surrounding situation of the vehicle and the state of the vehicle in accordance with the acquired detection result.

10. A computer-readable non-transitory recording medium recording a program for causing a computer to
acquire a detection result of a detection sensor that detects at least one of a surrounding situation of a vehicle and a state of the vehicle, and
cause a vibration device mounted on a driving manipulation element of the vehicle to generate vibrations simulating a texture indicating at least one of the surrounding situation of the vehicle and the state of the vehicle in accordance with the acquired detection result.
